(19) United States
(12) Patent Application Publication
(10) Pub. No.: US 2011/0145159 A1
(43) Pub. Date: Jun. 16, 2011

(54) METHODS AND SYSTEMS FOR REAL ESTATE AGENT TRACKING AND EXPERTISE DATA GENERATION

(75) Inventors: James Wilson, Lafayette, CA (US); Jeffrey McNeill, Sunnyvale, CA (US); Michael Davis, Pleasant Hill, CA (US); Mark Silva, Berkeley, CA (US); Genevieve C. Combes, Piedmont, CA (US)

(73) Assignee: ZipRealty, Inc., Emeryville, CA (US)

(21) Appl. No.: 13/027,114

(22) Filed: Feb. 14, 2011

Related U.S. Application Data
(60) Provisional application No. 61/428,753, filed on Dec. 30, 2010.

(51) Int. Cl. G06Q 50/00

(52) U.S. Cl. 705/313

(57) ABSTRACT

Disclosed herein is a real estate management application with a “property check-in” feature that enables the agent to automatically check-in at each property location. Subsequent to entering a given property, the agent selects the check-in feature in a mobile real estate service application, allowing the real estate service to determine a present geographic location of the agent. Using this, the service identifies an MLS location of the client and uses corresponding MLS information to update a tracking entry associated with the agent. In embodiments, the tracking entry enables the real estate service to maintain accurate expertise history for each agent.

### CROSS REFERENCE TO RELATED APPLICATIONS

This application claims priority to U.S. Provisional Application No. 61/428,753, entitled REAL ESTATE MANAGEMENT APPLICATIONS filed Dec. 30, 2010, which is hereby incorporated by reference in its entirety.

This patent application is related to the technologies described in the following patents and applications, all of which are incorporated herein in their entireties:

U.S. Patent Application No. ______, entitled METHODS AND SYSTEMS FOR PRIORITIZING CALL INITIATION IN A REAL ESTATE MANAGEMENT APPLICATION, filed concurrently herewith;

U.S. Patent Application No. ______, entitled METHODS AND SYSTEMS FOR TRANSMITTING LOCATION BASED AGENT ALERTS IN A REAL ESTATE APPLICATION, filed concurrently herewith;

U.S. Patent Application No. ______, entitled LEAD ALLOCATION IN REAL ESTATE APPLICATIONS USING INCOMING CLIENT'S GEOGRAPHIC POSITION, filed concurrently herewith;

U.S. Patent Application No. ______, entitled LEAD ALLOCATION IN REAL ESTATE APPLICATIONS USING DYNAMIC AGENT ALLOCATION WEIGHTAGES, filed concurrently herewith;

U.S. Patent Application No. ______, entitled VIRTUAL BIDDING PLATFORM FOR LEAD ALLOCATION IN REAL ESTATE APPLICATIONS, filed concurrently herewith.

### FIELD

The present invention generally relates to the field of electronic real estate management applications. More particularly, the present invention relates to methods and systems for tracking real estate agents based on their geographic location and further generating agent expertise data.

### BACKGROUND

The rapid growth in digital and Internet technology has revolutionized the real estate industry. These days, a vast majority of real estate transactions are performed online. Examples of such real estate transactions may include a client searching through online property listings, a real estate agent scheduling viewing-tours with clients, an agent drafting and transmitting offers for purchase of property, etc.

Traditionally, the agents are engaged in several tours each day, either touring different houses with the same client, or touring different houses with different clients, or both. It is often cumbersome for the agents to record and keep track of the houses they actually visit on a given day. An agent would have to painstakingly maintain a log of all the places she visited and provide such information to a real estate service management application. Because of the number of tours an agent does in a day, the agent may also potentially miss entering information regarding some of the houses the agent may have toured.

Accurately tracking and recording this information is important for several reasons. First, for example, when an agent tours several houses in a given neighborhood, or gains a specialty in touring a certain type of houses (e.g., specialty in touring seaside or river-front houses), such information can be gainfully advertised to potential clients as the agent's expertise in such fields. Additionally, when a potential consumer is in the process of selecting an agent, such expertise information would be beneficial as at least one of the factors in helping the client make a choice on an agent.

Apart from tracking the agents' tours or for expertise reasons, in some instances, a company operating the real estate management service may want to track the agents' tours or visits for other reasons. For example, the agents' compensation or reimbursement may be tied to the number of tours the agent does. In other instances, the tracking information may be useful for internal agent evaluation purposes.

Current technologies are deficient in offering a systematic and efficient mechanism to automatically track the agents' visits and develop corresponding expertise information. Overall, the examples herein of some prior or related systems and their associated limitations are intended to be illustrative and not exclusive. Other limitations of existing or prior systems will become apparent to those of skill in the art upon reading the following Detailed Description.

### SUMMARY OF THE DESCRIPTION

In one embodiment, a real estate management application offers a “property check-in” feature that enables the agent to automatically check-in at each property location. In an illustrative embodiment, subsequent to entering a given property, the agent selects the check-in feature in the mobile real estate service application (i.e., an application offered via the agent's mobile computing device). Subsequently, the real estate service determines a present geographic location of the agent utilizing, for example, the mobile device's geo-location capabilities. Using this location, the real estate service searches for MLS listed property locations at or near the user's location. Using this information, the real estate service determines that the agent is currently at a particular property for touring that property. As will be explained in the Detailed Description, the real estate service may employ additional verification mechanisms to ensure accuracy of such a determination. Subsequently, the real estate service extracts MLS information related to the specific property that the user is located at. In one embodiment, the real estate service extracts this MLS information, and uses such information to update an “expertise entry” associated with the agent.

In some instances, the expertise entry may just be a data structure, maintained in the database associated with the agency server, to keep track of the agent's expertise. In an exemplary embodiment, the expertise entry could include several variables. For example, the expertise entry could include variables such as “house type,” “neighborhood,” etc. Each of these variables could have several sub-categories. For example, a house type could include subcategories such as condo, apartment, etc. Typically, the sub-categories are tied to MLS listing terms. Accordingly, when an agent is tracked to have visited a house that is identified as an “apartment” (i.e., based on the MLS listing information extracted for the house), the real estate service then increments a tracking value maintained for the “apartment” subcategory under the house type variable. Extending this process to other such categories and variables, the tracking entry enables the real estate service to maintain accurate expertise history for each agent.

Other advantages and features will become apparent from the following description and claims. It should be understood that the description and specific examples are intended for purposes of illustration only and not intended to limit the scope of the present disclosure.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 and the following discussion provide a brief, general description of a representative environment in which the invention can be implemented;

FIGS. 2A-2B depict exemplary illustrations of a real estate management application for use by a real estate agent;

FIG. 3 depicts an exemplary display confirming an MLS match to a real estate agent's present geographic location;

FIGS. 4A-4C depict embodiments illustrating mechanisms that utilize the expertise information gathered for a given real estate agent;

FIG. 5 is a flow diagram depicting a high level process for tracking a real estate agent's property visits;

FIGS. 6A-6B depict exemplary illustrations of a location alert application;

FIG. 7 is an example of a networking website with a display of the alert transmitted by the real estate service;

FIG. 8 is a high level flow diagram illustrating a process that the real estate service utilizes to issue location alerts; and

FIG. 9 is a high-level block diagram showing an example of the architecture for a computer system.

The headings provided herein are for convenience only and do not necessarily affect the scope or meaning of the claimed invention.

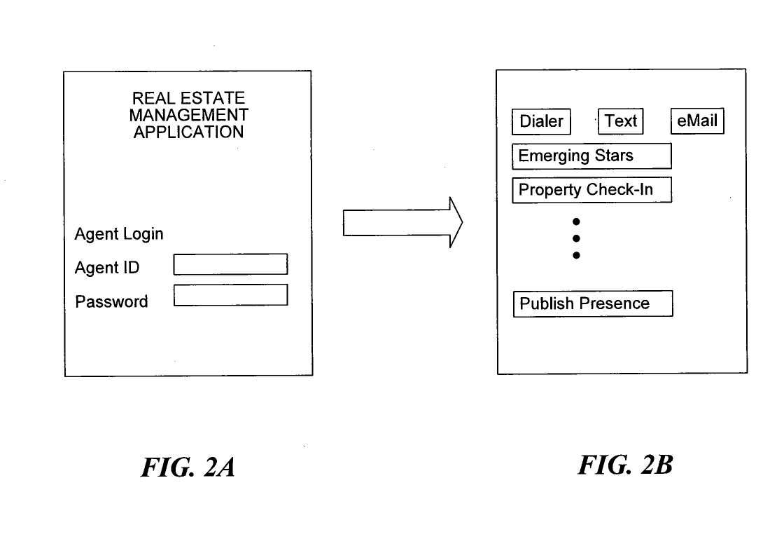

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 204 is first introduced and discussed with respect to FIG. 2).

### DETAILED DESCRIPTION OF THE INVENTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

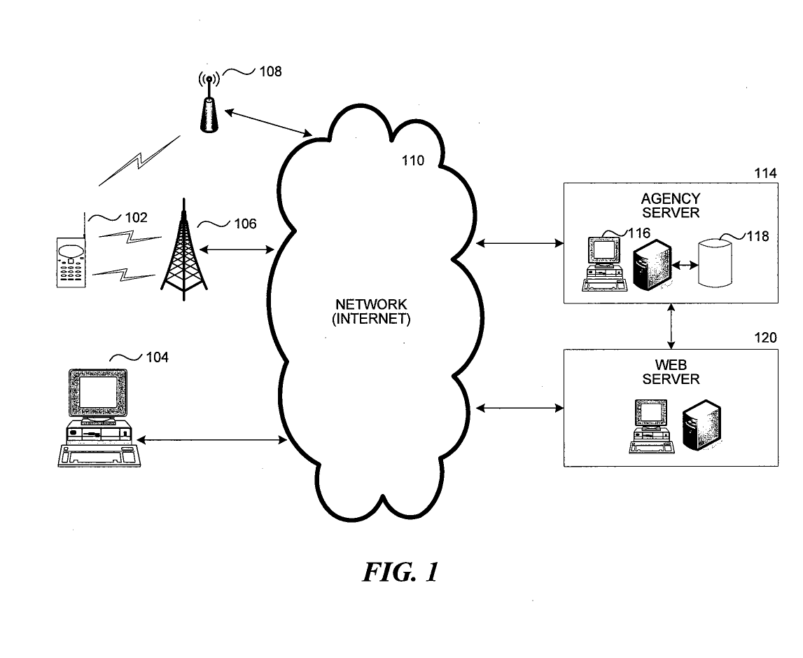

FIG. 1 and the following discussion provide a brief, general description of a representative environment in which the invention can be implemented. Although not required, aspects of the invention may be described below in the general context of computer-executable instructions, such as routines executed by a general-purpose data processing device (e.g., a server computer or a personal computer). Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” and the like are used interchangeably herein, and may refer to any of the above devices and systems.

While aspects of the invention, such as certain functions, are described as being performed exclusively on a single device, the invention can also be practiced in distributed environments where functions or modules are shared among disparate processing devices. The disparate processing devices are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the invention may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

As shown in FIG. 1, a user may use a personal computing device (e.g., a phone 102, a personal computer 104, etc.) to communicate with a network. The term “phone,” as used herein, may be a cell phone, a personal digital assistant (PDA), a portable email device (e.g., a Blackberry®), a portable media player (e.g., an IPod Touch®), or any other device having communication capability to connect to the network. In one example, the phone 102 connects using one or more cellular transceivers or base station antennas 106 (in cellular implementations), access points, terminal adapters, routers or modems 108 (in IP-based telecommunications implementations), or combinations of the foregoing (in converged network embodiments).

In some instances, the network 110 is the Internet, allowing the phone 102 (with, for example, WiFi capability) or the personal computer 104 to access web content offered through various web servers. In some instances, especially where the phone 102 is used to access web content through the network 110 (e.g., when a 3G or an LTE service of the phone 102 is used to connect to the network 110), the network 110 may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

In some instances, a user uses one of the personal computing devices (e.g., the phone 102, the personal computer 104, etc.) to connect to an agency server 114 through the network 110. In one embodiment, the agency server 114 comprises a server computer 116 coupled to a local database 118. The term “agency server” as indicated herein, refers to a server station or other computing apparatus capable of hosting a web service that is accessible by other computing systems (e.g., the personal computer 104) through, for example, the Internet.

In embodiments, the agency server 114 illustrated in FIG. 1 operates, or offers for operation, an electronic real estate management application. The term “electronic real estate management application” (or simply, a “real estate service”) as indicated herein, refers to a suite of operations or applications that may include, for example, a management application for real estate agents. As will be explained in further detail herein, such an application would allow the agent to, for example, manage and coordinate user profiles or potential buyers (or clients) engaged with the agent for the purpose of purchasing real estate in a particular location, managing offer submission and contract generation, managing and overseeing client activity, establish communication with clients through one or more communication media (e.g., embedded telephone application, embedded text or email application, etc.), track client location, publish agent's present geographic location, etc. The agency server 114 may utilize the associated database 118 to store and manage contact information and all other data related to the above mentioned examples.

In embodiments, the functionalities of the real estate service may be processed entirely within the agency server 114, operated via a graphical user interface from the user's computing device (102 or 104). For example, the agency server 114 may offer a web based interface to the various functionalities, allowing a user to control or operate the functionalities using web based interfaces via the user's computing device. In such instances, the agency server 114 handles all database related operations (e.g., retrieving the contacts associated with an agent, retrieving user profile information, retrieving previously saved contracts and other paperwork for a particular client, etc.) in a client-server architecture, allowing the computing device to receive and display such information. In embodiments, however, it is understood that the functionalities of the real estate service described herein may be handled and operated entirely in a stand-alone manner entirely from the computing device. It is further understood that the exemplary functionalities described herein may be performed in any other architecture as may be understood by a person of ordinary skill in the art.

As indicated in the example above, in some instances, the agency server 114 may also operate as a web server to enable the functionalities of the real estate service to be offered over a local network or the Internet. In such instances, the agency server 114 may operate additionally as a web server or may be coupled to a separate web server 120 to provide the web functionalities. Further, as shown in FIG. 1, the personal computing devices (e.g., 102, 104) and the agency server 114 are connected through the network 110 to one or more web servers (e.g., web server 120).

### Agent Tracking and Expertise Data Generation

As will be explained in additional detail below, in one embodiment, the real estate service offers a management application for real estate agents to, for example, coordinate and manage real estate activities related to their clients. In one example, such a real estate application includes a feature that enables the real estate service to track an agent's touring history and extract corresponding expertise information for the agent. Traditionally, the agents are engaged in several tours each day, either touring different houses with the same client, or touring different houses with different clients, or both. It is often cumbersome for the agents to record and keep track of the houses they actually visited. An agent would have to painstakingly keep a log of all the places she visited and provide such information to a real estate service management application. Because of the number of tours an agent does in a day, the agent may also potentially miss entering information regarding some of the houses the agent may have toured.

Accurately tracking and recording this information is important for several reasons. First, when an agent tours, for example, several houses in a given neighborhood, or gains a specialty in touring a certain type of houses (e.g., specialty in touring seaside or riverfront houses), such information can be gainfully advertised to potential clients as the agent's expertise in such fields. Additionally, when a potential consumer is in the process of selecting an agent, such expertise information would be beneficial as at least one of the factors in helping the client make a choice on an agent.

Apart from tracking the agents' tours or for expertise reasons, in some instances, a company operating the real estate management service may want to track the agents' tours for other reasons. For example, the agents' compensation or reimbursement may be tied to the number of tours the agent does. In other instances, the tracking information may be useful for internal agent evaluation purposes. Automatic verification and tracking capabilities would therefore be beneficial for a multitude of reasons.

In one embodiment, the real estate management application offers a “property check-in” feature that enables the agent to automatically check-in at each property location. In an illustrative embodiment, subsequent to entering a given property, the agent selects the check-in feature in the mobile real estate service application (i.e., an application offered via the agent's mobile computing device). Subsequently, the real estate service determines a present geographic location of the agent utilizing, for example, the mobile device's geo-location capabilities (e.g., inbuilt GPS capabilities). Using this location, the real estate service searches for MLS listed property locations at or near the user's location. Using this information, the real estate service determines that the agent is currently at a particular property for touring that property. As will be explained below, the real estate service may employ additional verification mechanisms to ensure accuracy of such a determination. Subsequently, the real estate service extracts MLS information related to the specific property that the user is located at. MLS (or Multiple Listing Service), as defined herein, refers to listing information provided for real estate properties. An MLS listing for a property typically includes extensive information about the property such as, for example, property type (e.g., house, condo, town house, etc.), asking price, address information, location information (e.g., county, neighborhood, etc.), views (e.g., oceanfront, city view, etc.), etc. In one embodiment, the real estate service extracts this MLS information, and uses such information to add to or update an “expertise entry” associated with the agent.

In some instances, the expertise entry may just be a data structure maintained in the database associated with the agency server to keep track of the agent's expertise. In exemplary embodiment, the expertise entry could include several variables. For example, the expertise entry could include variables such as “house type,” “neighborhood,” etc. Each of these variables could have several sub-categories. For example, a house type could include subcategories such as a condo, an apartment, etc. Typically, the sub-categories are tied to MLS listing terms. Accordingly, when an agent is tracked to have visited a house that is identified as an “apartment” (i.e., based on the MLS listing information extracted for the house), the real estate service then increments a tracking value maintained for the “apartment” subcategory under the house type variable. Extending this process to other categories and other variables, the tracking entry enables the real estate service to maintain accurate expertise history for each agent. This expertise information may be utilized and presented in a variety of manners, some of which will be discussed in the following sections.

FIGS. 2A-2B depict exemplary illustrations of a real estate management application for use by a real estate agent. In one embodiment, an agent invokes the real estate management application (real estate application) 210 on a computing device 104. As illustrated in FIG. 2A, the real estate application first requires the agent to login to a service account associated with the agent. Upon logging in, the real estate application 210 presents an overview page, presenting the various functionalities available to the use, as illustrated in FIG. 2B. It is noted that FIG. 2B is merely an exemplary depiction of some of the potential features made available to the agent, and is not intended as a comprehensive embodiment. In the example of FIG. 2B, the agent is presented with a list of contacts associated with the agent. In one example, the real estate service 210 groups the contacts under one or more categories. For example, a first category 260 groups all contacts that have previously been designated as emerging stars. As described herein, an emerging star could be a client that shows immense potential value in purchasing a property in the immediate future, or one that purchases real estate properties on a regular basis, or simply any client that is attractive to the agent from a business perspective.

In embodiments, the overview page may also include a “property check-in” feature, enabling the agent to check-in to a property the agent is currently located at. As discussed above, this information will be useful in tracking and generating expertise information for the agent. Typically, an agent would check-in after entering the property that the agent wishes to tour. The agent would conventionally enter the apartment by means of a lockbox mechanism. Functionalities of such a lockbox mechanism are well understood by people of ordinary skill in the art. The agent typically has a lockbox “key” (typically an electronic device) that the agent uses to retrieve the property's actual physical key. Subsequent to entering the property, the agent activates the property check feature 262 of the mobile real estate management application service. Upon enabling this feature, and as discussed above, the real estate service determines a current geographic location of the user (e.g., by tapping into the resources offered by the mobile device) and attempts to map it to a specific MLS entry at the same location.

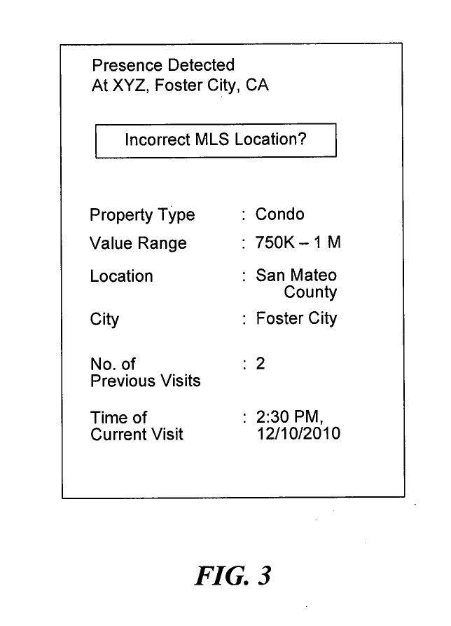

The real estate service may perform this matching in one of several ways. In one example, if the real estate service identifies only one MLS entry at the immediate vicinity of the identified location, it then automatically assigns that location as the specific MLS location that the agent is at. A display similar to the display illustrated in FIG. 3 may be presented to the user to confirm the match. In one example, the real estate service may simply display an indicator of the specific MLS entry to the user asking for the user's confirmation.

There may be scenarios where the real estate service identifies multiple MLS listings at the same location. For example, a single apartment building may have multiple open listings. In that scenario, for example, the real estate service may cause indicators of these MLS listings to be displayed to the agent, and assign a particular MLS entry as the current MLS location based on the agent's selection of one of the indicators.

In some instances, the real estate service may perform additional routines to ensure that the agent is actually in the specific MLS location. In one example, the real estate service may query a log of the lockbox entries and identify a most recent lockbox entry for the specific MLS location. The real estate service then verifies the most recent lockbox entry against the agent's lockbox access code to ensure that the agent is actually in the specific MLS location.

Subsequent to making a successful match, the real estate service extracts MLS information related to the specific MLS location. Examples of such MLS attributes are illustrated in FIG. 3. As discussed above, in embodiments, the real estate service maintains an expertise entry for the purpose of tracking the agent's expertise. The real estate service then identifies each attribute in the MLS information and correlates it to (or adds it to) the categories stored in association with the expertise entry. For example, if the agent visited a house that is listed at $1.2M, the real estate service correlates this to a category titled “$1M-$1.5M.” In an exemplary embodiment, the real estate service maintains a count value of each category, and increments the count value for the categories that match or correlate against the MLS information in the specific MLS location. Accordingly, the expertise entry serves to maintain the expertise and tracking history of the agent based on actual agent visits to various MLS locations.

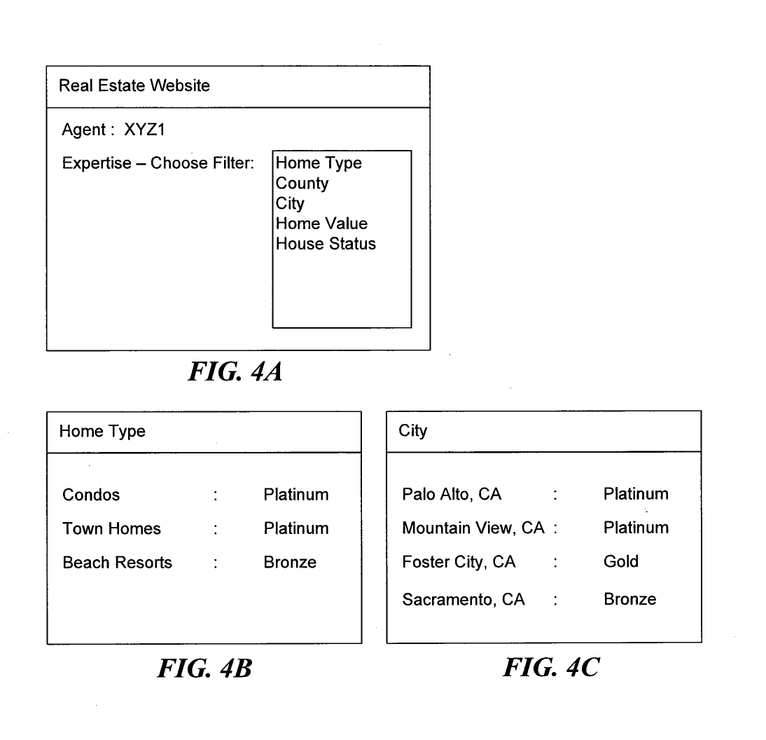

FIGS. 4A-4C illustrate embodiments of how the expertise information may be utilized. Of course, it is understood that other implementations, as understood by a person of ordinary skill in the art, to effectively utilize and display the expertise information, are also contemplated as equivalents of the techniques discussed herein. FIG. 4A provides an example of how a user navigating the real estate service's website may view an agent's expertise history. For example, after identifying a particular agent, the user chooses an “expertise filter.” The user may optionally filter the expertise results based on one of these categories (i.e., the categories maintained in association with the expertise entry). In a first example, as illustrated in FIG. 4B, the user filters results based on “home type.” The agent illustrated in this example has a platinum ranking for condos and town homes, and a bronze for beach resorts. In this example, the real estate service internally maintains definitions for each of these rankings. For example, the ranking could be: platinum for 100 or more visits within the last 6 months to properties of that category; gold for 75-100 visits within the last 6 months; and so on. Accordingly, this display gives the user an immediate idea as to the agent's expertise in dealing with condo and town home type of properties. A similar example based on city location is illustrated in FIG. 4C.

In another embodiment (not shown in FIG. 4), the real estate service could also rank all its agents based on a particular category. For example, if a user is interested in determining agents with the most expertise in houses around the Palo Alto area, the user could potentially request a listing of all agents with expertise in the Palo Alto area. Using the expertise entry maintained for each agent, the real estate service could then easily provide a listing and expertise level/ranking of each of its agents that have previously toured in the Palo Alto area.

Additionally, as discussed above, the techniques discussed herein further enable the real estate service to maintain an accurate record of locations toured/visited by the agent. The agent would not be able to alter the record as the visits and tours are automatically captured based on the agent's actual physical presence in the MLS property, and because, in some embodiments, the presence is further validated using queries to lockbox logs.

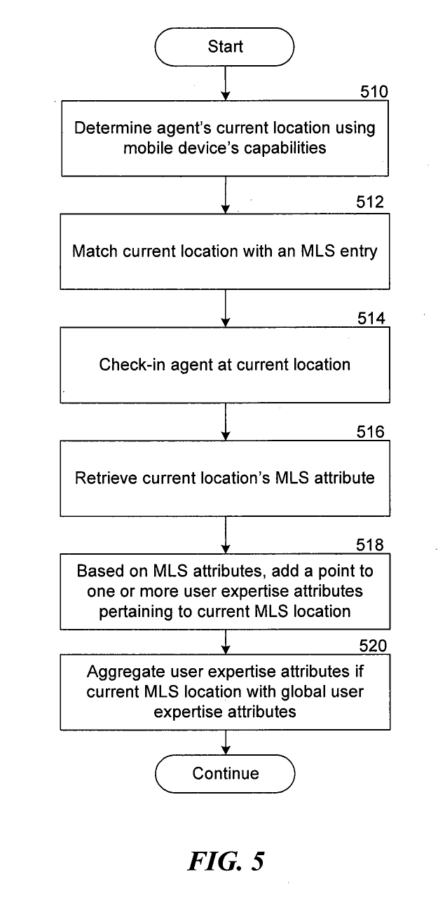

FIG. 5 is a flow diagram depicting a high level process for tracking a real estate agent's property visits. In one embodiment, the process beings at step 510, where the real estate service determines the agent's current geographic location using capabilities of the agent's mobile device. Subsequently, at step 512, the real estate service matches the agent's current location with an MLS entry relevant to the current location. Using the identified MLS location, the real estate service “checks in” the agent at the current location. In some instances, as discussed above, the real estate service may perform other verification routines (e.g., verification of one MLS location when multiple listings are identified in the same location, verification against a lockbox entry log, etc.). The process then proceeds to step 518, where the real estate service retrieves MLS attributes for the identified MLS location. Subsequently, at step 520, the real estate service aggregates the information from the MLS attributes to corresponding categories maintained in an expertise entry associated with the agent.

### Agent Location Alerts

As will be explained in additional detail below, in one embodiment, the real estate service offers a management application for real estate agents to, for example, coordinate and manage real estate activities related to their clients. In one example, such a real estate application includes a feature that enables the real estate service to automatically publish alerts relating to specific places the agent tours or visits. A real estate agent may typically have tens to hundreds of clients at any given time. With the increase in use of internet technology in real estate applications, clients may be assigned to agents even before the agent has an opportunity to get to know the client or the client's preferences. Often, when an agent visits a particular property (e.g., while touring with a particular client), the agent may recall another client who may also be interested in the property. If the agent had a sufficient history of touring with the other client, the agent may even recognize that the other client would have liked the location or the structure of the property. However, there are two factors that potentially preclude the real estate agent from being able to inform her other clients of locations that they may be interested in. First, when the agent tours several multiple locations on the same day, the features of the various properties blur in the agent's mind by the end of the day. To avoid this issue, the agent would have to inform (i.e., make a call to) her other clients right when she is visiting the location. However, while touring with her current client, out of politeness and out of business etiquette, the agent is usually unable to make a call to her other clients during the tour. Second, given the number of clients the agent may have on her roster at any given time, it is often cumbersome for the agent to remember or identify other clients that may potentially be interested in the current property. The techniques described herein, with respect to the “location alert” feature of the real estate service address these problems and provide other benefits as discussed below.

In one embodiment, when a real estate agent invokes the “location alert” option, for example, using the real estate management application installed on her mobile device, the real estate service automatically retrieves the current geographic location of the agent (e.g., using geo-location capabilities of the agent's mobile device). Using this information, the real estate service identifies a specific MLS location that the agent is currently located at. For example, the real estate service may identify the closest MLS listing to the agent's current location and identify that MLS listing as the specific MLS location of the agent. In other examples, similar to the ones discussed with respect to the expertise tracking application, the real estate service may implement a suite of operations to identify the specific MLS location of the agent. In some instances, the real estate service may also validate the specific MLS location by querying the agent's most recent lockbox access entry and matching it against the lockbox details associated with the specific MLS location.

Subsequent to identifying the specific MLS location, the real estate service identifies and retrieves MLS listing information corresponding to the specific MLS location. The real estate service also retrieves a list of the agent's clients from a database associated with, for example, the agency server.

In some instances, the real estate service maintains preference information associated with each client. In some instances, the clients may have indicated their preference in properties they desire. For example, the client may have indicated he is interested in houses in Folsom, Calif., or that he is interested in a lake-view property. In such instances, the real estate service maintains their preferences in association with their profile. In some instances, the clients may have indicated certain preferences to the agent in prior tours, and the agents could then annotate such preferences in association with the client's profile. In some instances, the client may have indicated their interest in a specific property that may have not been available for sale. In such instances, the real estate service may extract MLS information related to the unavailable house and store such preferences in association with the client's profile. In some instances, the real estate service may internally run preference routines to track the client's prior search history to identify certain preference patterns (e.g., based on price, location, etc.) and maintain such preferences in association with the client's profile. Additionally, any other process used for determining a client's preference, as understood by a person of ordinary skill in the art, may equally be applied in conjunction with the techniques discussed herein.

Returning back to the location alert feature, the real estate service identifies the agent's clients and also accesses the profile information (or at least the preference information associated with the clients' profiles). The real estate service also identifies and retrieves MLS information associated with the specific MLS location (i.e., the agent's current location). The real estate service then performs one or more operations to identify a subset of the agent's clients that may be interested in the current property. The real estate service may, for example, compare the MLS information of the current property against known client preferences from the client profile and determine the subset of targeted clients. In one example, the real estate service may identify a list of clients who previously expressed interest in the current property or in the current neighborhood. In one example, the subset of targeted clients may simply include new clients that signed up with the real estate service. In one example, the targeted subset could also just include all of the agent's clients. In one example, the targeted subset could include users currently using a client version of the mobile real estate application. Other such examples of matching the user's preferences against the current property, as understood by a person of ordinary skill in the art, may also be equally applied herein.

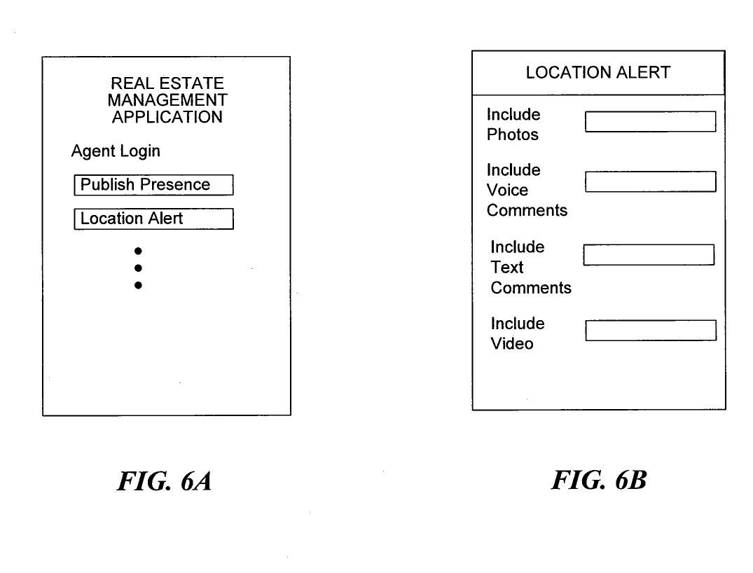

Subsequent to identifying the targeted subset of clients, the real estate service transmits an alert to the targeted subset. The alert may be sent using one or more transmission methods, depending on a variety of factors. In one example, the alert may be blasted via email or text message. In one example, the alert may be transmitted based on preferences previously established by the client. Additionally, as illustrated in FIG. 6B, the agent may also include additional information along with the alert. For example, the agent may use his mobile device to capture additional pictures and/or videos of the property. The user may also capture a personalized narrative of the property (in some instances, the narrative may be in conjunction with the video). The real estate service then incorporates all this information, along with other information about the agent and the current property, and transmits the alert to the targeted subset of clients.

In this manner, the agent is relieved of the hassle of having to identify specific clients who may be interested in a property that the agent is currently viewing. The agent simply has to activate the location alert feature, and the real estate service automatically captures information about the current location, identifies potential clients that may be interested in the current location, and blasts out personalized alerts with information that the clients would not otherwise be able to access.

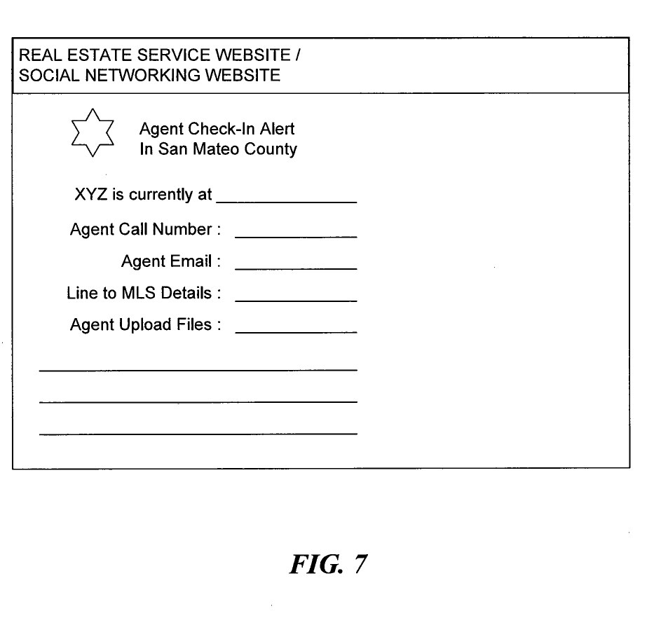

In embodiments, in addition to the transmission of above alerts, or in lieu of such alerts, the real estate service may also publish the alerts in networking websites. A networking website, as defined herein, includes any website that allows clients to access information posted by the agent. In one example, the networking website may just be a website operated by the real estate service. In another example, the networking website may be a social networking website (e.g., Facebook.com®, Twitter.com®, etc.). Here, the real estate service may have clients in the form of “followers” or “friends” that follow information posted by the real estate service. In such instances, the real estate service automatically posts the alert information on the website, with links to all the additional information uploaded by the client. In some examples, the networking website could be a third-party website, where the real estate service posts the alert information in the form of an advertisement. An example of such a posting in a networking website is illustrated in FIG. 7.

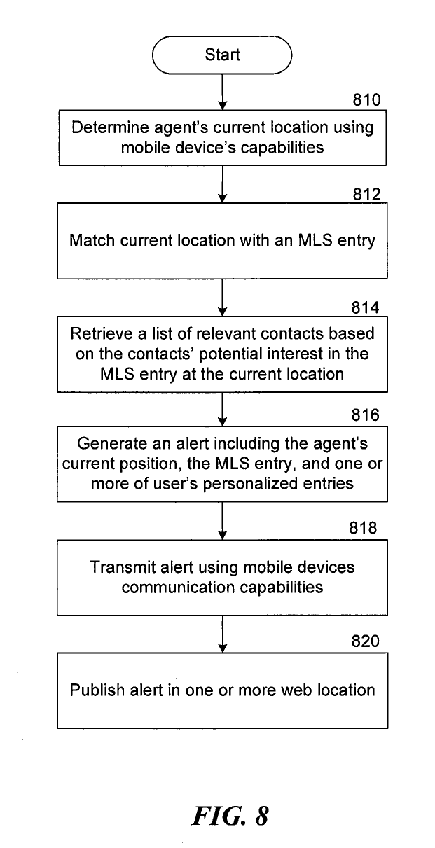

FIG. 8 is a high level flow diagram illustrating a process that the real estate service utilizes to issue location alerts. The process starts at step 810, where the real estate service determines the agent's current geographic location using the agent's mobile device. At step 812, the real estate service matches the user's geographic location with a specific MLS location. Subsequently, at step 814, the real estate service retrieves a list of the agents' clients and identifies a targeted subset of clients that may potentially be interested in the current property. At step 816, the real estate service generates an alert utilizing the information provided by the agent and blasts the alert to the targeted subset at step 818. Finally, at step 820, the real estate service optionally publishes the alert in one or more networking websites.

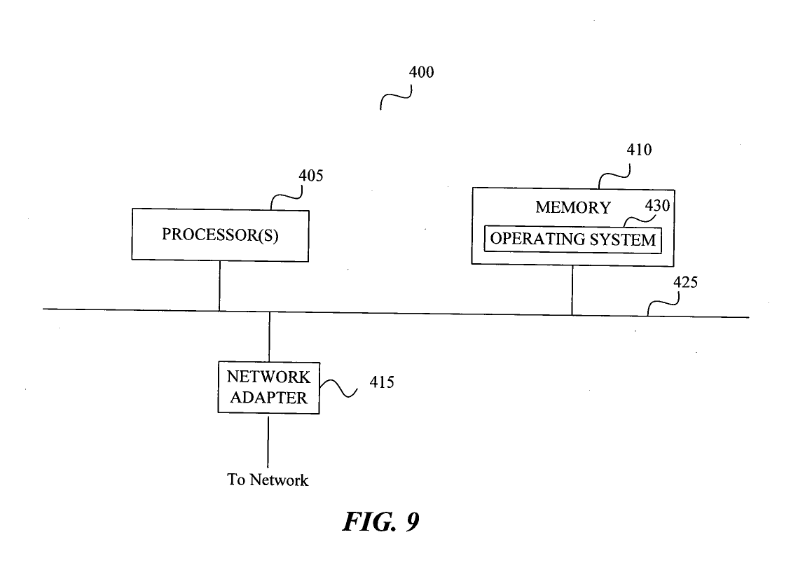

FIG. 9 is a high-level block diagram showing an example of the architecture for a computer system 400 that can be utilized to implement a agency server (e.g., 114 from FIG. 1), a web server (e.g., 125 from FIG. 1), a computing device (102, 104), etc. In FIG. 4, the computer system 400 includes one or more processors 405 and memory 410 connected via an interconnect 625. The interconnect 425 is an abstraction that represents any one or more separate physical buses, point to point connections, or both connected by appropriate bridges, adapters, or controllers. The interconnect 425, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineer (IEEE) standard 694 bus, sometimes referred to as “Firewire”.

The processor(s) 605 may include central processing units (CPUs) to control the overall operation of, for example, the host computer. In certain embodiments, the processor(s) 405 accomplish this by executing software or firmware stored in memory 410. The processor(s) 405 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 410 is or includes the main memory of the computer system 1100. The memory 410 represents any form of random access memory (RAM), read-only memory (ROM), flash memory (as discussed above), or the like, or a combination of such devices. In use, the memory 410 may contain, among other things, a set of machine instructions which, when executed by processor 405, causes the processor 405 to perform operations to implement embodiments of the present invention.

Also connected to the processor(s) 405 through the interconnect 425 is a network adapter 415. The network adapter 415 provides the computer system 400 with the ability to communicate with remote devices, such as the storage clients, and/or other storage servers, and may be, for example, an Ethernet adapter or Fiber Channel adapter.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶ 6 will begin with the words “means for.”) Accordingly, the applicant reserves the right to add additional claims after filing the application to pursue such additional claim forms for other aspects of the invention.

We claim:

1. A method for tracking a real estate agent's property visits, the method comprising:
receiving the real estate agent's current location based on a geographic position of the real estate agent's wireless device;
matching the real estate agent's current location with a specific MLS-listed property located at or near the real estate agent's current location; and
automatically designating the real estate agent as having visited the specific MLS-listed property in an expertise entry associated with the real estate agent.

2. The method of claim 1, wherein the expertise entry includes one or more categories, each category corresponding to a specific MLS attribute.

3. The method of claim 2, wherein automatically designating the real estate agent as having toured the specific MLS-listed property in an expertise entry further comprises:
retrieving MLS entries associated with the specific MLS-listed property;
for each of the one or more categories included in the expertise entry, identifying a corresponding MLS entry associated with the specific MLS-listed property;
incrementing an expertise value associated with each of the one or more categories, wherein the expertise value for a given category is indicative of a total number of visits by the real estate agent to properties that include the given category as a native MLS attribute.

4. The method of claim 2, further comprising:
subsequent to identifying the real estate agent's current location and the specific MLS-listed property, and prior to automatically designating the real estate agent as having visited the specific MLS-listed property, verifying the real estate agent's physical entry into the specific MLS-listed property.

5. The method of claim 4, wherein verifying the real estate agent's physical entry further comprises:
identifying a most recent lockbox key entry associated with the specific MLS-property;
verifying the most recent lockbox key entry against a lockbox designator associated with the real estate agent; and
proceeding with the automatic designation that the real estate agent visited the specific MLS-listed property only when the most recent lockbox entry verifies against the lockbox designator associated with the real estate agent.

6. The method of claim 1, wherein matching the real estate agent's current location with a specified MLS-listed property further comprises:
if only one MLS-listing is identified at or near the real estate agent's current location, identifying the one MLS-listing as the specific MLS-listed property; and
if a plurality of MLS-listings is identified at or near the real estate agent's current location:
displaying indicators of the plurality of MLS-listings to the real estate agent;
receiving the real estate agent's selection of one of the indicators;
identifying a given MLS-listing corresponding to the user's selection as the specific MLS-listed property.

7. The method of claim 2, wherein the expertise entry is utilized to generate and display an expertise history of the real estate agent.

8. The method of claim 5, wherein the expertise entry is utilized to track and verify a real estate agent's visit to one or more given MLS properties.

9. A method for tracking a real estate agent's property visits, the method comprising:
receiving the real estate agent's current location based on a geographic position of the real estate agent's wireless device;
matching the real estate agent's current location with a specific MLS-listed property located at or near the real estate agent's current location;
identifying a most recent lockbox key entry associated with the specific MLS-property;
verifying the most recent lockbox key entry against a lockbox designator associated with the real estate agent;
subsequent to a successful verification, automatically designating the real estate agent as having visited the specific MLS-listed property in a tracking entry associated with the real estate agent.

10. The method of claim 9, wherein matching the real estate agent's current location with a specified MLS-listed property further comprises:
if only one MLS-listing is identified at or near the real estate agent's current location, identifying the one MLS-listing as the specific MLS-listed property; and
if a plurality of MLS-listings is identified at or near the real estate agent's current location:
displaying indicators of the plurality of MLS-listings to the real estate agent;
receiving the real estate agent's selection of one of the indicators;
identifying a given MLS-listing corresponding to the user's selection as the specific MLS-listed property.

11. A method for tracking a real estate agent's property visits to develop the real estate agent's expertise information, the method comprising:
receiving the real estate agent's current location based on a geographic position of the real estate agent's wireless device;
matching the real estate agent's current location with a specific MLS-listed property located at or near the real estate agent's current location;
automatically designating the real estate agent as having visited the specific MLS-listed property in an expertise entry associated with the real estate agent, wherein the expertise entry includes one or more categories, each category corresponding to a specific MLS attribute;
retrieving MLS entries associated with the specific MLS-listed property;
for each of the one or more categories included in the expertise entry, identifying a corresponding MLS entry associated with the specific MLS-listed property; and
incrementing an expertise value associated with each of the one or more categories, wherein the expertise value for a given category is indicative of a total number of visits by the real estate agent to properties that include the given category as a native MLS attribute.

12. The method of claim 11, further comprising:
subsequent to identifying the real estate agent's current location and the specific MLS-listed property, and prior to automatically designating the real estate agent as having visited the specific MLS-listed property, verifying the real estate agent's physical entry into the specific MLS-listed property.

13. The method of claim 12, wherein verifying the real estate agent's physical entry further comprises:
identifying a most recent lockbox key entry associated with the specific MLS-property;
verifying the most recent lockbox key entry against a lockbox designator associated with the real estate agent; and
proceeding with the automatic designation that the real estate agent visited the specific MLS-listed property only when the most recent lockbox entry verifies against the lockbox designator associated with the real estate agent.

14. A system for tracking a real estate agent's property visits, the system comprising:
a processor;
a memory configured to store a set of instructions, which when executed by the processor cause the system to perform a method, the method including:
receiving the real estate agent's current location based on a geographic position of the real estate agent's wireless device;
matching the real estate agent's current location with a specific MLS-listed property located at or near the real estate agent's current location; and
automatically designating the real estate agent as having visited the specific MLS-listed property in an expertise entry associated with the real estate agent.

15. The system of claim 14, wherein the expertise entry includes one or more categories, each category corresponding to a specific MLS attribute.

16. The system of claim 15, wherein automatically designating the real estate agent as having toured the specific MLS-listed property in an expertise entry further comprises:
retrieving MLS entries associated with the specific MLS-listed property;
for each of the one or more categories included in the expertise entry, identifying a corresponding MLS entry associated with the specific MLS-listed property;
incrementing an expertise value associated with each of the one or more categories, wherein the expertise value for a given category is indicative of a total number of visits by the real estate agent to properties that include the given category as a native MLS attribute.

17. The system of claim 15, wherein the method further comprises:
subsequent to identifying the real estate agent's current location and the specific MLS-listed property, and prior to automatically designating the real estate agent as having visited the specific MLS-listed property, verifying the real estate agent's physical entry into the specific MLS-listed property.

18. The system of claim 17, wherein verifying the real estate agent's physical entry further comprises:
identifying a most recent lockbox key entry associated with the specific MLS-property;
verifying the most recent lockbox key entry against a lockbox designator associated with the real estate agent; and
proceeding with the automatic designation that the real estate agent visited the specific MLS-listed property only when the most recent lockbox entry verifies against the lockbox designator associated with the real estate agent.

19. The system of claim 14, wherein matching the real estate agent's current location with a specified MLS-listed property further comprises:
if only one MLS-listing is identified at or near the real estate agent's current location, identifying the one MLS-listing as the specific MLS-listed property; and
if a plurality of MLS-listings is identified at or near the real estate agent's current location:
displaying indicators of the plurality of MLS-listings to the real estate agent;
receiving the real estate agent's selection of one of the indicators;
identifying a given MLS-listing corresponding to the user's selection as the specific MLS-listed property.
